(19) United States
(12) Patent Application Publication
(10) Pub. No.: US 2003/0196535 A1
(43) Pub. Date: Oct. 23, 2003

(54) Belt saw machine with a belt cutter that is easy to replace

(76) Inventor: Pei-Lieh Chiang, Taichung City (TW)

Correspondence Address: TROP PRUNER & HU, PC, 8554 KATY FREEWAY, SUITE 100, HOUSTON, TX, 77024, US

(21) Appl. No.: 10/278,234

(22) Filed: Oct. 23, 2002

(30) Foreign Application Priority Data
Apr. 22, 2002 (TW) 091205433

(51) Int. Cl. B23D 53/00

(52) U.S. Cl. 83/818

(57) ABSTRACT

A belt saw machine includes an upright base frame, a cutter unit, a roller mounting arm, a biasing unit, and a pushing unit. The upright base frame has upper and lower frame portions. The cutter unit includes an upper drive roller, a lower drive roller, and a belt cutter. The roller mounting arm is pivoted to the upper frame portion, and has the upper drive roller mounted rotatably thereon. The biasing unit acts on the roller mounting arm for pivoting the roller mounting arm from a belt-slackening position to a belt-tightening position. The pushing unit is mounted movably on the upper frame portion, and is operable so as to apply a pushing force on the roller mounting arm for moving the roller mounting arm from the belt-tightening position to the belt-slackening position against action of the biasing unit.

### CROSS-REFERENCE TO RELATED APPLICATION

This application claims priority of Taiwanese application no. 091205433, filed on Apr. 22, 2002.

### BACKGROUND OF THE INVENTION

1. Field of the Invention

The invention relates to a belt saw machine, more particularly to a belt saw machine with a belt cutter that is easy to replace.

2. Description of the Related Art

Referring to FIG. 1, a conventional belt saw machine 10 is shown to include an upright base frame 11, a cutter unit 13, a slide block 14, and a cutter dismantler 15. The upright base frame 11 has an upper frame portion 111, a lower frame portion 112, and a notch 113 formed between the upper and lower frame portions 111, 112. The cutter unit 13 includes an upper drive roller 131 disposed rotatably on the upper frame portion 111, a lower drive roller 132 mounted rotatably to the lower frame portion 112, and an endless belt cutter 133 trained on the upper and lower drive rollers 131, 132. A portion of the belt cutter 133 is exposed from the base frame 11 at the notch 113. The slide block 14 is slidable upwardly and downwardly relative to the upper frame portion 111, and has the upper drive roller 131 mounted rotatably thereon. The slide block 14 is formed with a threaded hole 141. The cutter dismantler 15 includes a lever 151 and a threaded fastener 152 connected to the lever 151 and extending through the upper frame portion 111 for threadedly engaging the threaded hole 141 in the slide block 14.

With further reference to FIG. 2, when the lever 151 is operated to rotate the threaded fastener 152 in a first direction, in view of the threaded engagement between the slide block 14 and the threaded fastener 152, the slide block 14 can move upwardly relative to the upper frame portion 111, thereby moving the upper drive roller 131 away from the lower drive roller 132 so as to dispose the belt cutter 133 in a tensed or tightened state. On the other hand, when the threaded fastener 152 is rotated in an opposite second direction, the slide block 14 moves downwardly relative to the upper frame portion 111, thereby moving the upper drive roller 131 toward the lower drive roller 132 so as to dispose the belt cutter 133 in a loose or slackened state. The belt cutter 133 can be removed for replacement at this time.

The following are some of the drawbacks of the conventional belt saw machine 10:

1. Quick attachment or replacement of the belt cutter 133 is not possible because of the need to rotate the threaded fastener 152 before the upper drive roller 131 can be moved toward or away from the lower drive roller 132.

2. Proper adjustment of the tension of the belt cutter 133 cannot be conveniently conducted. When the threaded fastener 152 is excessively rotated such that the tension of the belt cutter 133 is too high, the belt cutter 133 tends to break easily. On the other hand, when the tension of the belt cutter 133 is too low, the belt cutter 133 will be unable to cut a work piece properly.

### SUMMARY OF THE INVENTION

Therefore, the main object of the present invention is to provide a belt saw machine that can overcome the aforesaid drawbacks associated with the prior art.

Accordingly, a belt saw machine of this invention comprises:

an upright base frame having upper and lower frame portions;

a cutter unit including an upper drive roller, a lower drive roller mounted rotatably to the lower frame portion, and an endless belt cutter trained on the upper and lower drive rollers;

a roller mounting arm pivoted to the upper frame portion and having the upper drive roller mounted rotatably thereon;

a biasing unit acting on the roller mounting arm for pivoting the roller mounting arm from a belt-slackening position, where the belt cutter is loosely held on the upper and lower drive rollers, to a belt-tightening position, where the upper drive roller is moved away from the lower drive roller so as to hold the belt cutter tightly between the upper and lower drive rollers; and

a pushing unit mounted movably on the upper frame portion and operable so as to apply a pushing force on the roller mounting arm for moving the roller mounting arm from the belt-tightening position to the belt-slackening position against action of the biasing unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional belt saw machine;

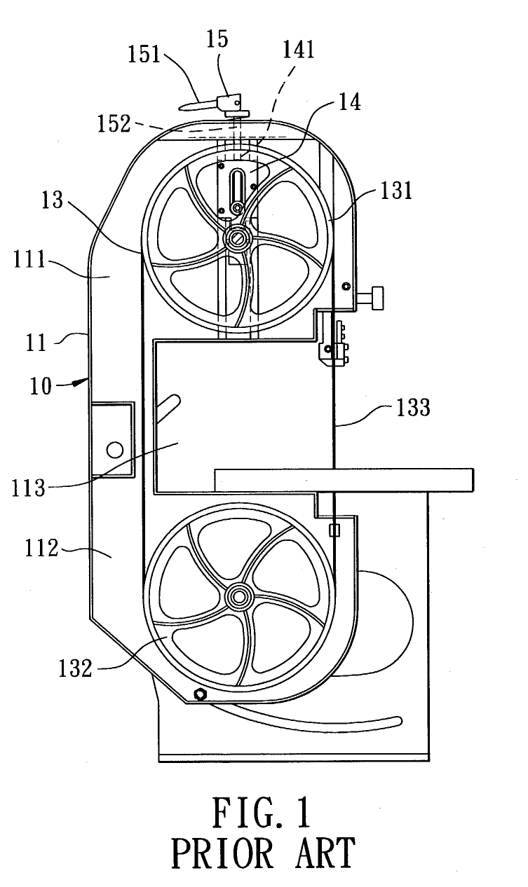

FIG. 2 is a fragmentary schematic view illustrating how a belt cutter is replaced in the conventional belt saw machine of FIG. 1;

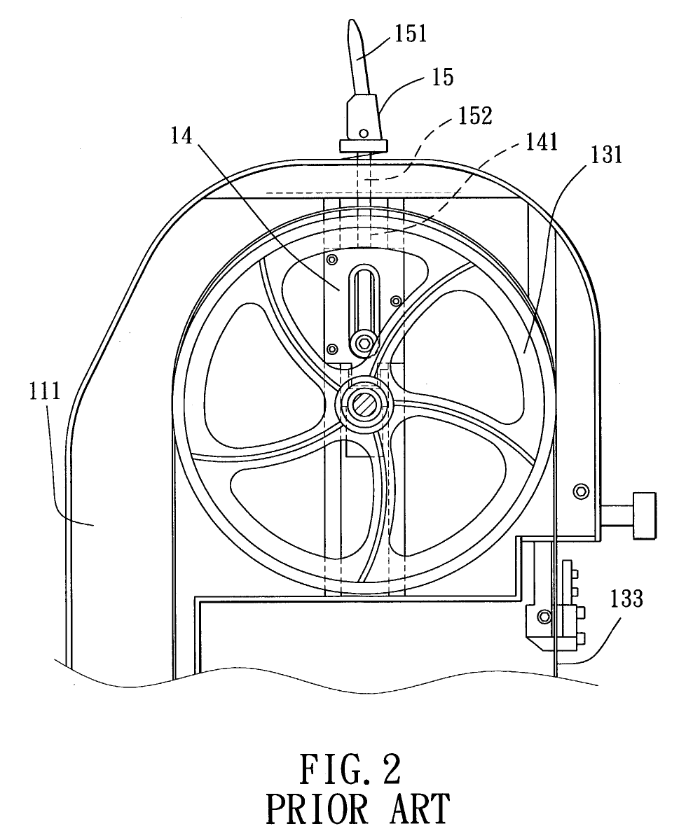

FIG. 3 is a schematic front view showing the preferred embodiment of a belt saw machine according to the present invention;

FIG. 4 is a schematic rear view of the preferred embodiment;

FIG. 5 is a fragmentary schematic view showing the preferred embodiment when a belt cutter thereof is in a slackened state; and

FIG. 6 is a fragmentary schematic view showing the preferred embodiment when the belt cutter is in a tightened state.

### DETAILED DESCRIPTION OF THE PREFERRED EMBODIMENT

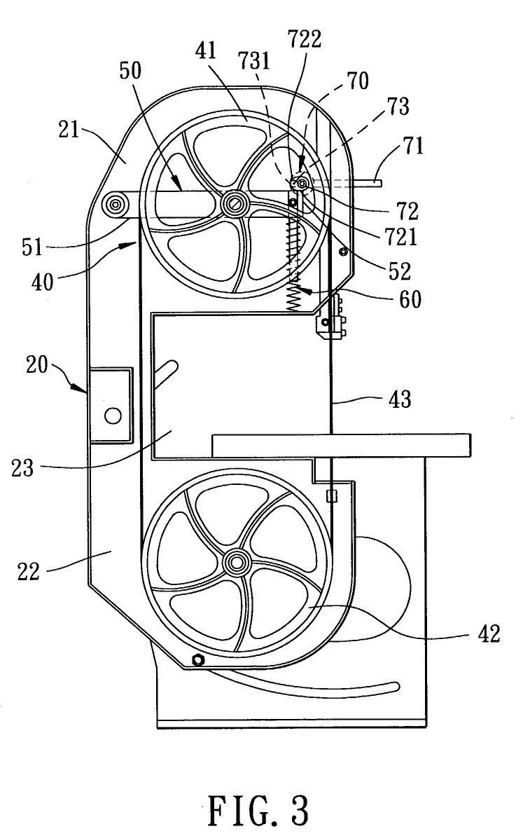

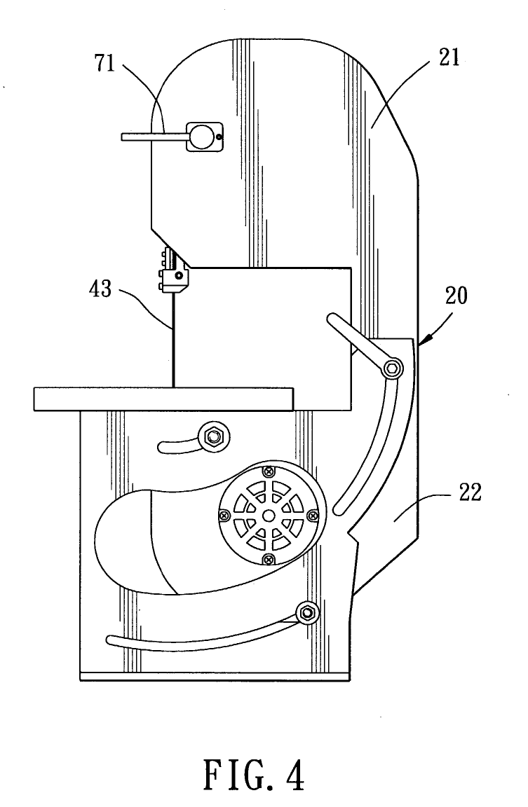

Referring to FIGS. 3 and 4, the preferred embodiment of a belt saw machine according to the present invention is shown to include an upright base frame 20, a cutter unit 40, a roller mounting arm 50, a biasing unit 60, and a pushing unit 70.

The upright base frame 20 is generally C-shaped, and has an upper frame portion 21, a lower frame portion 22, and a notch 23 formed between the upper and lower frame portions 21, 22.

The cutter unit 40 includes an upper drive roller 41, a lower drive roller 42 mounted rotatably to the lower frame portion 22, and an endless belt cutter 43 trained on the upper and lower drive rollers 41, 42. A portion of the belt cutter 43 is exposed from the base frame 20 at the notch 23.

The roller mounting arm 50 has a pivot end 51 mounted pivotally on the upper frame portion 21, and a biasing end 52 opposite to the pivot end 51. The upper drive roller 41 is mounted rotatably on the roller mounting arm 50 between the pivot and biasing ends 51, 52.

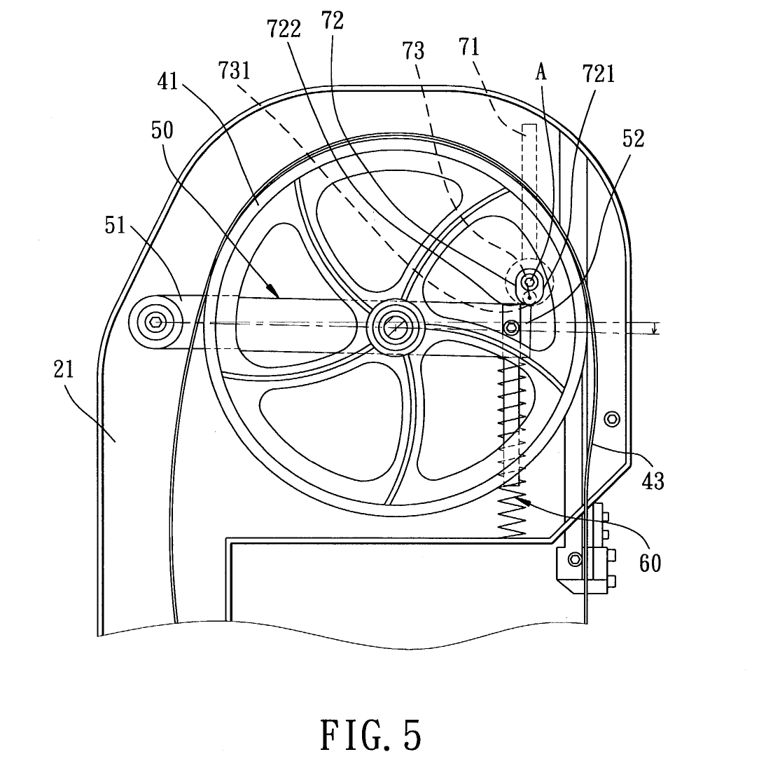

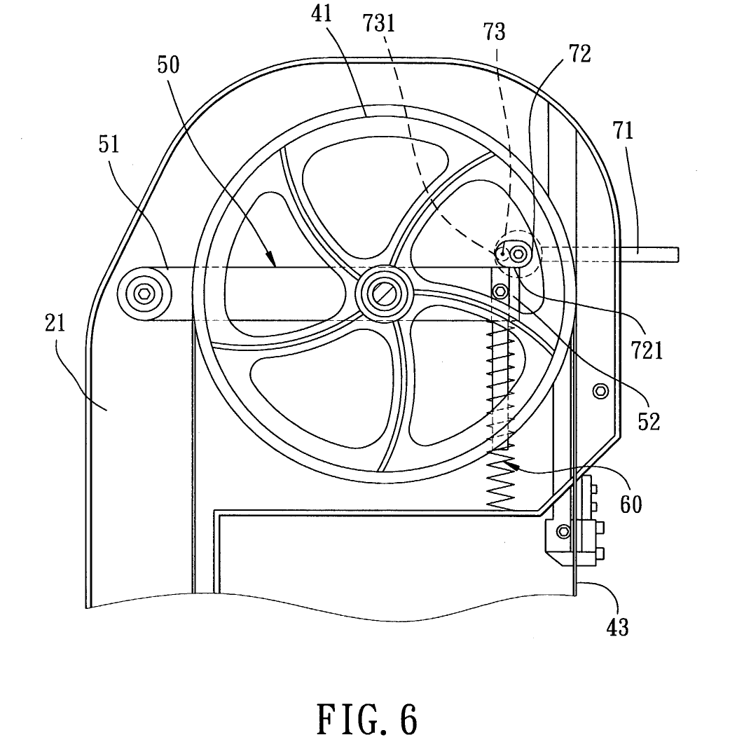

The biasing unit 60 has one end abutting against the lower frame portion 21, and another end abutting against the biasing end 52 of the roller mounting arm 50. The biasing unit 60 thus acts on the roller mounting arm 50 for pivoting the roller mounting arm 50 from a belt-slackening position (see FIG. 5), where the belt cutter 43 is loosely held on the upper and lower drive rollers 41, 42, to a belt-tightening position (see FIG. 6), where the upper drive roller 41 is moved away from the lower drive roller 42 so as to hold the belt cutter 43 tightly between the upper and lower drive rollers 41, 42. In this embodiment, the biasing unit 60 includes a coiled compression spring.

The pushing unit 70 is mounted movably on the upper frame portion 21 and is operable so as to apply a pushing force on the roller mounting arm 50 for moving the roller mounting arm 50 from the belt-tightening position to the belt-slackening position against action of the biasing unit 60. In this embodiment, the pushing unit 70 includes a lever 71, a roller mounting block 72 and a contact roller 73. The lever 71 has one end coupled to the roller mounting block 72, and the other end exposed from the upper frame portion 21. The roller mounting block 72 is mounted on the upper frame portion 21 and is rotatable about a pivot axis (A) that is disposed above the biasing end 52 of the roller mounting arm 50. The roller mounting block 72 further has a stop edge 721 spaced apart from the pivot axis (A) by a first distance, and a remote edge 722 spaced apart from the pivot axis (A) by a second distance longer than the first distance. The contact roller 73 is mounted rotatably on the roller mounting block 72 adjacent to the remote edge 722, and is offset from the pivot axis. The contact roller 73 further has a contact edge 731 (see FIG. 5) that projects slightly in radial outward directions relative to the remote edge 722 of the roller mounting block 72.

Referring further to FIG. 5, when it is desired to replace the belt cutter 43, the lever 71 of the pushing unit 70 is rotated to extend vertically, thereby rotating the roller mounting block 72 so as to dispose the contact roller 73 between the pivot axis (A) and the biasing end 52 of the roller mounting arm 50. At this time, the contact edge 731 of the contact roller 73 abuts against the biasing end 52 of the roller mounting arm 50 and applies the pushing force for pivoting the roller mounting arm 50 about the pivot end 51, thereby moving the roller mounting arm 50 from the belt-tightening position to the belt-slackening position against the action of the biasing unit 60. As a result, the upper drive roller 41 is moved downwardly toward the lower drive roller 42 (see FIG. 3) so that the belt cutter 43 is slackened to permit removal of the same from the upper and lower drive rollers 41, 42.

Referring further to FIG. 6, when it is desired to tighten the belt cutter 43, the lever 71 is rotated to extend horizontally, thereby rotating the roller mounting block 72 so as to move the contact roller 73 away from the biasing end 52 of the roller mounting arm 50, and so that the stop edge 721 of the roller mounting block 72 confronts the biasing end 52 of the roller mounting arm 50. At this time, due to the action of the biasing unit 60, the biasing end 52 of the roller mounting arm 50 is pushed upward, thereby causing the roller mounting arm 50 to pivot about the pivot end 51 from the belt-slackening position to the belt-tightening position such that the biasing end 52 of the roller mounting arm 50 abuts against the stop edge 721 of the roller mounting block 72. The stop edge 721 of the roller mounting block 72 arrests further upward pivoting movement of the roller mounting arm 50 at this time. As a result of movement of the roller mounting arm 50 to the belt-tightening position, the upper drive roller 41 is moved upwardly away from the lower drive roller 42 (see FIG. 3) so that the belt cutter 43 is tightened. The belt cutter 43 is ready to be used for sawing a work piece at this time.

It has thus been shown that, in the belt saw machine of this invention, quick attachment or replacement of the belt cutter 43 is possible by merely rotating the lever 71. Moreover, proper adjustment of the tension of the belt cutter 43 can be ensured due to the engagement between the roller mounting block 72 and the biasing end 52 of the roller mounting arm 50 when the latter is in the belt-tightening position.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A belt saw machine comprising:
an upright base frame having upper and lower frame portions;
a cutter unit including an upper drive roller, a lower drive roller mounted rotatably to said lower frame portion, and an endless belt cutter trained on said upper and lower drive rollers;
a roller mounting arm pivoted to said upper frame portion and having said upper drive roller mounted rotatably thereon;
a biasing unit acting on said roller mounting arm for pivoting said roller mounting arm from a belt-slackening position, where said belt cutter is loosely held on said upper and lower drive rollers, to a belt-tightening position, where said upper drive roller is moved away from said lower drive roller so as to hold said belt cutter tightly between said upper and lower drive rollers; and
a pushing unit mounted movably on said upper frame portion and operable so as to apply a pushing force on said roller mounting arm for moving said roller mounting arm from the belt-tightening position to the belt-slackening position against action of said biasing unit.

2. The belt saw machine as claimed in claim 1, wherein said base frame is generally C-shaped and has a notch between said upper and lower frame portions, a portion of said belt cutter being exposed from said base frame at said notch.

3. The belt saw machine as claimed in claim 1, wherein said roller mounting arm has a pivot end mounted pivotally on said upper frame portion, and a biasing end opposite to said pivot end, said upper drive roller being mounted on said roller mounting arm between said pivot and biasing ends, said biasing unit having one end abutting against said upper frame portion and another end abutting against said biasing end of said roller mounting arm.

4. The belt saw machine as claimed in claim 3, wherein said biasing unit includes a coiled compression spring.

5. The belt saw machine as claimed in claim 1, wherein said pushing unit includes a roller mounting block mounted on said upper frame portion and rotatable about a pivot axis that is disposed above said roller mounting arm, a contact roller mounted rotatably on said roller mounting block and offset from said pivot axis, and a lever having one end coupled to said roller mounting block, said lever being operable to rotate said roller mounting block so as to dispose said contact roller between said pivot axis and said roller mounting arm, thereby enabling said contact roller to contact said roller mounting arm and apply the pushing force for moving said roller mounting arm from the belt-tightening position to the belt-slackening position.

6. The belt saw machine as claimed in claim 5, wherein said roller mounting block has a stop edge spaced apart from said pivot axis by a first distance, said contact roller having a contact edge spaced apart from said pivot axis by a second distance longer than the first distance,
said stop edge arresting upward pivoting movement of said roller mounting arm when said roller mounting block is rotated to enable said stop edge to abut against said roller mounting arm,
said contact edge abutting against said roller mounting arm when said roller mounting block is rotated to dispose said contact roller between said pivot axis and said roller mounting arm.
